(19) United States
(12) Patent Application Publication
(10) Pub. No.: US 2024/0362255 A1
(43) Pub. Date: Oct. 31, 2024

(54) METHOD AND MAPPING SERVER FOR GENERATING MAPPING INFORMATION FOR CLOUD EVENTS

(71) Applicant: ASTRON SECURITY INC., Seoul (KR)

(72) Inventors: Keun Seok CHO, Anyang-si (KR); Dong Ik KWAK, Hwaseong-si (KR)

(21) Appl. No.: 18/469,725

(22) Filed: Sep. 19, 2023

(30) Foreign Application Priority Data
Apr. 28, 2023 (KR) 10-2023-0056206
Jul. 7, 2023 (KR) 10-2023-0088478

(51) Int. Cl. G06F 16/28; G06F 16/242

(52) U.S. Cl. CPC G06F 16/285; G06F 16/243

(57) ABSTRACT

Disclosed is a method and mapping server for generating mapping information for a cloud event. The method includes: obtaining a document for any one mapping target event; generating at least one of a topic and a keyword for the mapping target event based on the document; based on at least one of the topic and the keyword, selecting one tactic to which the mapping target event is mapped; based on at least one of the topic and the keyword, selecting a technique to which the mapping target event is mapped; storing mapping information for the mapping target event in a mapping dictionary; and generating mapping information for each event and storing the generated mapping information in the mapping dictionary, thereby generating a mapping dictionary for at least some of the plurality of events.

### BACKGROUND OF THE DISCLOSURE

### Field of disclosure

The present disclosure relates to a technology for determining a user's action based on a cloud event, and more particularly, a method for generating a mapping information for a cloud event to map each cloud event received in a cloud computing environment to at least one of a plurality of tactics and at least one of a plurality of techniques.

### Related Art

Due to the recent advancements and extensive utilization of cloud technology, cloud computing services have become ubiquitous. As the cloud computing services have become widespread, the importance of detecting and defending against security-threatening user actions in a cloud computing environment is increasing.

In the cloud computing environment, a user's actions are collected as events through an API, and the types of the events collected vary depending on the user's actions. However, different types of events are sometimes generated for the same user's specific action in cloud servers of different operators, and the correspondence between the user's specific action and the types of events are not defined.

Thus, even if an event is collected, it is difficult to determine a user's action in real time. In particular, it is difficult to immediately determine a series of adversary actions by a user.

Accordingly, there is an increasing demand for immediately determining whether a user's action is adversary.

### RELATED DOCUMENT

### Patent Document

(Patent Document 1) Korean Patent Application Publication No. 10-2419451 (published date: Jul. 11, 2022)

### SUMMARY OF THE DISCLOSURE

An aspect of the present disclosure provides a method and mapping server for generating mapping information for a cloud event to map a mapping target event among a plurality of events to at least one tactic and at least one technique, the tactic and technique which specify actions to cope with the mapping target event.

Another aspect of the present disclosure provides a method for generating mapping information for a cloud event, the mapping information including risk information for a mapping target event at a time of generating the mapping information.

In one aspect, there is provided a method for generating mapping information for a plurality of events provided by a cloud service by a mapping server. The mapping server is capable of using an action database comprising a plurality of techniques included in any one of a plurality of tactics, and the method includes: (a) obtaining a document for any one mapping target event, wherein the mapping target event is any one of the plurality of events; (b) generating at least one of a topic and a keyword for the mapping target event based on the document; (c) selecting one tactic to which the mapping target event is mapped, based on at least one of the topic and the keyword; (d) selecting a technique to which the mapping target event is mapped, based on at least one of the topic and the keyword, wherein the selected technique is included in the selected tactic; (e) storing mapping information for the mapping target event according to (c) and (d) in a mapping dictionary; and (f) generating a mapping dictionary for at least some of the plurality of events by repeating (a) to (d).

The method may further include: (g) obtaining information on an inquiry event from a client; (h) searching for a tactic corresponding to the inquiry event based on the mapping dictionary; (i) searching for one of a plurality of techniques included in the searched tactic; and (j) providing the client with the technique and tactic searched for with respect to the inquiry event as mapping information.

In (d), there may be included: selecting a plurality of techniques possibly mapped to the mapping target event; providing the plurality of techniques to at least one evaluator terminal; obtaining appropriateness information for the plurality of techniques from the at least one evaluator terminal; selecting one technique from among the plurality of techniques by collecting the appropriateness information; and storing mapping information for the mapping target event in the mapping dictionary.

The mapping information may include risk information for the mapping target event.

The risk information may include default risk information for the mapping target event and risk relevance information in which a first event occurring in sequence with the mapping target event is taken into consideration.

When the first event is plural, the risk relevance information may be matched with each first event.

When an inquiry event scenario having a plurality of inquiry events is received from a client, different risk information may be selected for each of the plurality of inquiry events in consideration of a technique or tactics of any other inquiry event occurring earlier in the inquiry event scenario.

The processor is further configured to perform the following: (k) identifying an undefined event not included in the mapping dictionary; (l) receiving risk assessment information on the undefined event from a client terminal; (m) based on the risk assessment information, selecting one of a first method for adding the undefined event to the mapping dictionary and a second method for classifying the undefined event as a non-risk event; and (n) in response to the first method being selected, storing mapping information, to which the undefined event is to be mapped, in a mapping dictionary.

The processor may be further configured to perform, after (m) and prior to (n), receiving mapping-related information for the undefined event from the client terminal, and in (n), the mapping information may be generated based on the mapping-related information.

The mapping-related information may be based on at least one of topic and keyword information of the undefined event.

The processor may be further configured to perform, after (m) and prior to (n), receiving mapping-related information for the undefined event from a generative AI server by requesting the mapping-related information from the generative AI server.

In (n), the mapping information may be generated based on the mapping-related information.

The receiving of the mapping-related information may include: generating prompting information comprising information on the undefined event, the tactic, and the technique; obtaining reply information by transmitting the prompting information to the generative AI server; and identifying the mapping-related information from the reply information.

The receiving of the mapping-related information may include, prior to the generating of the prompting information, selecting at least one candidate tactic and at least one candidate technique based on topic and keyword information of the undefined event, and in the generating of the prompting information, the information on the tactic and the technique included in the prompting information may be information on the at least one candidate tactic and at least one candidate technique.

In another aspect, there is provided a mapping server for generating mapping information for a plurality of events provided by a cloud service, and the mapping server includes: a memory; an action database comprising a mapping dictionary, a plurality of tactics, and a plurality of techniques included in each of the plurality of tactics; and a processor connected to the memory and the action database and executing instructions stored in the memory. The processor is configured to perform the following: (a) obtaining a document for any one mapping target event, wherein the mapping target event is any one of the plurality of events; (b) generating at least one of a topic and a keyword for the mapping target event based on the document; (c) selecting one tactic to which the mapping target event is mapped, based on at least one of the topic and the keyword; (d) selecting a technique to which the mapping target event is mapped, based on at least one of the topic and the keyword, wherein the selected technique is included in the selected tactic; (e) storing mapping information for the mapping target event according to (c) and (d) in a mapping dictionary; and (f) generating a mapping dictionary for at least some of the plurality of events by repeating (a) to (d).

The processor may be further configured to perform the following: (g) obtaining information on an inquiry event from a client; (h) searching for a tactic corresponding to the inquiry event based on the mapping dictionary; (i) searching for one of a plurality of techniques included in the searched tactic; and (j) providing the client with the technique and tactic searched for with respect to the inquiry event as mapping information.

The processor may be further configured to perform the following in (d): selecting a plurality of technique information possibly mapped to the mapping target event; providing the plurality of techniques to at least one evaluator terminal; and obtaining appropriateness information for the plurality of techniques from the at least one evaluator terminal.

The processor may be further configured to perform the following: selecting one technique from among the plurality of techniques by collecting the appropriateness information; and storing mapping information for the mapping target event in the mapping dictionary.

The mapping information may include risk information for the mapping target event.

The risk information may include default risk information for the mapping target event and risk relevance information in which a first event occurring in sequence with the mapping target event is taken into consideration.

### BRIEF DESCRIPTION OF THE DRAWINGS

FIG. 1 is a diagram illustrating an example of a network environment according to an embodiment of the present disclosure.

FIG. 2 is a block diagram of a processor of a mapping server according to an embodiment of the present disclosure.

FIG. 3 is an overall flowchart of a method for generating mapping information for a cloud

event according to an embodiment of the present disclosure.

FIG. 4 is a flowchart illustrating a process when a mapping target event corresponds to a plurality of techniques according to an embodiment of the present disclosure.

FIG. 5 is a diagram illustrating an example of tactics and techniques according to an embodiment of the present disclosure.

FIG. 6 is a flowchart illustrating a process of generating risk information according to an embodiment of the present disclosure.

FIGS. 7(a) and 7(b) are diagrams illustrating an operation of determining a risk level based on a risk relevance in an action scenario according to a first embodiment of the present disclosure.

FIGS. 8(a) and 8(b) are diagrams illustrating an operation of determining a risk level based on a risk relevance in an action scenario according to a second embodiment of the present disclosure.

FIG. 9 is an overall flowchart of a method for mapping an undefined event according to an embodiment of the present disclosure.

FIG. 10 is an overall flowchart of a method for receiving mapping-related information from a generative AI server according to an embodiment of the present disclosure.

### DESCRIPTION OF EXEMPLARY EMBODIMENTS

Hereinafter, the present disclosure will be described in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

As used herein, the singular forms “a”, “an,” and “the” are intended to include the plural forms as well, unless the context clearly indicates otherwise.

In this specification, operations described may be performed regardless of a listed order, except for a case where they must be performed in the listed order due to a special causal relationship.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the accompanying drawings.

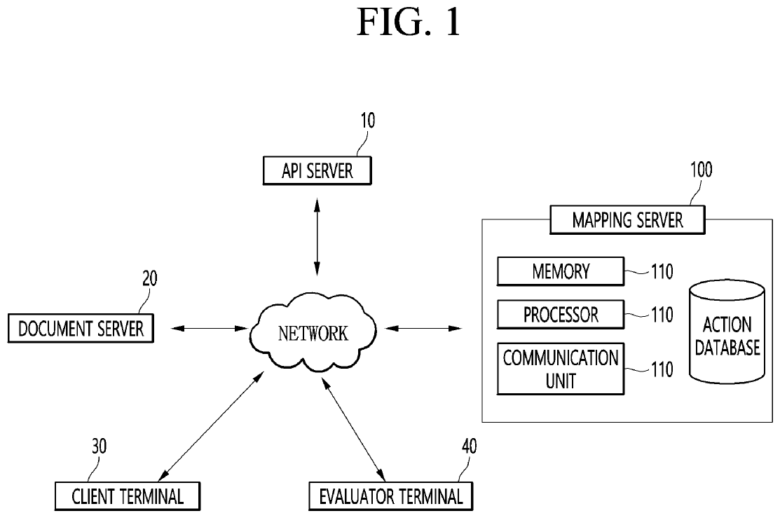

FIG. 1 is a diagram illustrating an example of a network environment according to an embodiment of the present disclosure.

A network environment according to an embodiment of the present disclosure shown in FIG. 1 may include an API server 10, a document server 20, a client terminal 30, an evaluator terminal 40, and a mapping server 100.

The API server 10 is a device that executes an application programming interface (API) according to a predetermined rule or upon a user's request. When an API is executed in the API server 10, an event corresponding to the API may be generated. Event information may include an event name of the executed API, an execution time of the API, an executing body of the API, and a response syntax of the event. Here, the response syntax may refer to grammar of information generated by the API server 10 as a result of execution of the API. The API server 10 may provide the response syntax to a user terminal.

The API server 10 may include an event recorder that stores information on an API execution result. The event recorder may store, in the form of a database, event information corresponding to an API executed by the AIP server 10. The event recorder may be referred to as a cloud trail (CloudTrail) when the AIP server 10 is, for example, Amazon Web Service (AWS).

The document server 20 is a server that stores a document for events. Here, the document for the events may be document information describing a name, a definition, a function, and a request syntax format of each event, a description of a parameter generated or provided upon execution of an API, and a response syntax format. For example, an event may be output in the format of JSON, YAML, YAML stream, Text, Table, CSV, etc.

Such a document for events may be provided in the form of a web page or a downloadable document from the document server 20. The document for events may be provided in such a way that is classified and searchable by event name, or may be provided in the form of a list.

The document server 20 may be created and managed by the API server 10 executing an API of a provided document or by an associated entity of the AIP server 10. Accordingly, the document server 20 may selectively store documents of events executable in the API server 10. The associated entity creating and managing the document server 20 may be understood as a cloud operator including Amazon, Google, Microsoft, Oracle, and Naver that operate cloud computing services. Meanwhile, the document server 20 may be included and implemented in the mapping server 100.

The mapping server 100 may include a memory 110, a processor 120, a communication unit 130, and an action database 140.

The memory 110 serves as a storage medium, and may store a plurality of application programs running in the mapping server 100, and data and commands for operation of the mapping server 100.

By controlling overall operations of the memory 110, the communication unit 130, and the action database 140, the processor 120 may perform a method for generating mapping information for an event, provide mapping information on an inquiry event regarding an inquiry by the client terminal 30, and inquiry the evaluator terminal 40 for the mapping information for an event.

The processor 120 may collect event information from the event recorder of the API server 10 and collect documents for events included in the collected event information from the document server 20. The processor 120 may generate mapping information for each event based on the collected event information and documents, and store and manage the mapping information in a mapping dictionary in the action database 140.

Here, the mapping server 100 may be understood as software-as-a-service (SaaS) that provides an event mapping service to a user terminal through a cloud application or IT infrastructure and platform over an Internet browser.

The communication unit 130 may communicate with the API server 10, the document server 20, the client terminal 30, and the evaluator terminal 40 over a network in a wired or wireless manner.

The action database 140 stores information on a plurality of tactics and a plurality of techniques included in each tactic, and may store a mapping dictionary generated by the processor 120. The mapping dictionary refers to record information, in which a first event analyzed by the processor 120 and mapping information determined to correspond to the first event are matched with each other. The record information may be implemented in any of various forms, such as a table form. Mapping information matched with one event includes one tactic among a plurality of tactics and one technique among a plurality of techniques.

A tactic refers to a name defining a user's action that includes a normal action and a adversary action (hereinafter referred to as “tactical action”), and a technique refers to a name defining a detailed action for the tactic. When an event occurs, the processor 120 may determine whether the event is a normal action or an adversary action based on a tactic or technique for an API included in the event.

A plurality of tactics may be arbitrarily set by a manufacturer, and may be set based on a sequence of attack actions.

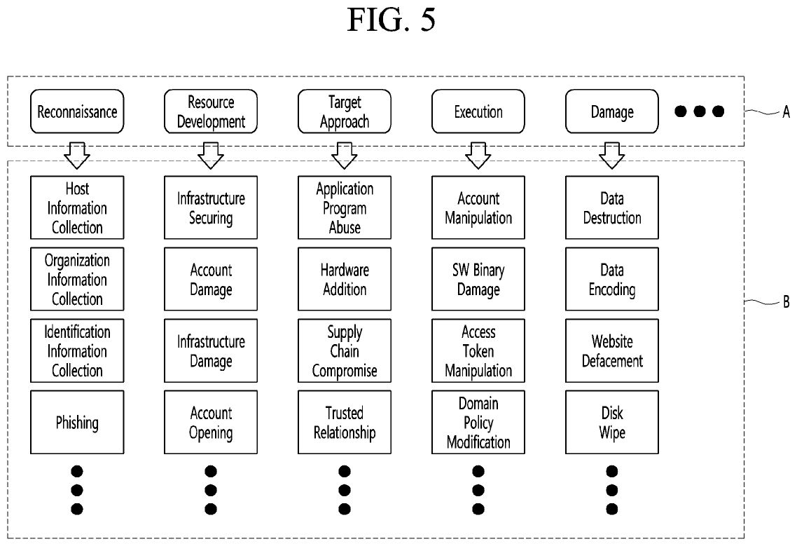

Examples of the plurality of tactics and the plurality of techniques will be described with reference to FIG. 5. FIG. 5 is a diagram illustrating examples of tactics and techniques according to an embodiment of the present disclosure.

Referring to FIG. 5, a plurality of tactics A may include Reconnaissance, Resource Development, Target Approach, Execution, Damage, and the like. Reconnaissance corresponds to an action of collecting and searching for information, Resource Development corresponds to an action of preparing resources (e.g., accounts, infrastructure, etc.) for a target act, Target Approach corresponds to an action of approaching a target action, Execution corresponds to a preceding action that causes the target action, and Damage corresponds to the target action.

A plurality of techniques B are specific actions corresponding to a tactic. For example, techniques B corresponding to Reconnaissance include host information collection, organization information collection, identification information collection, phishing, and the like, and techniques corresponding to Resource Development include infrastructure securing, account damage, infrastructure damage, account opening, and the like. Techniques corresponding to Target Approach include application program abuse, hardware addition, supply chain compromise, trusted relationship, etc., and Execution includes account manipulation, SW binary damage, access token manipulation, domain policy modification, etc.

Meanwhile, the action database 140 may store information on APIs executed in the API server 10. The information on APIs may be generated based on event information on APIs collected from the API server 10 and document information about events collected from the document server 31.

The client terminal 30 refers to a terminal that receives a mapping service for generating mapping information for an event, the service which is provided by the mapping server 100. In addition, the client terminal 30 may call an API by executing communication with the API server 10 according to a predetermined rule or upon a user's request. A result of an event executed by the API server 10 by a call of the client terminal 30 may be stored in the event recorder of the API server 10.

The evaluator terminal 40 is an evaluator terminal that evaluates which technique corresponds to a mapping target event requested from the processor 120. In this case, the processor 120 identifies a plurality of candidate techniques for the mapping target event and provides the plurality of candidate techniques to a plurality of evaluator terminals 40. Accordingly, the evaluator terminal 40 may evaluate appropriateness information for each candidate technique with respect to a mapping target API, and provide the processor 120 with the appropriateness information for each candidate technique. The appropriateness information refers to information on a degree (e.g., level or score) of matching with the mapping target event.

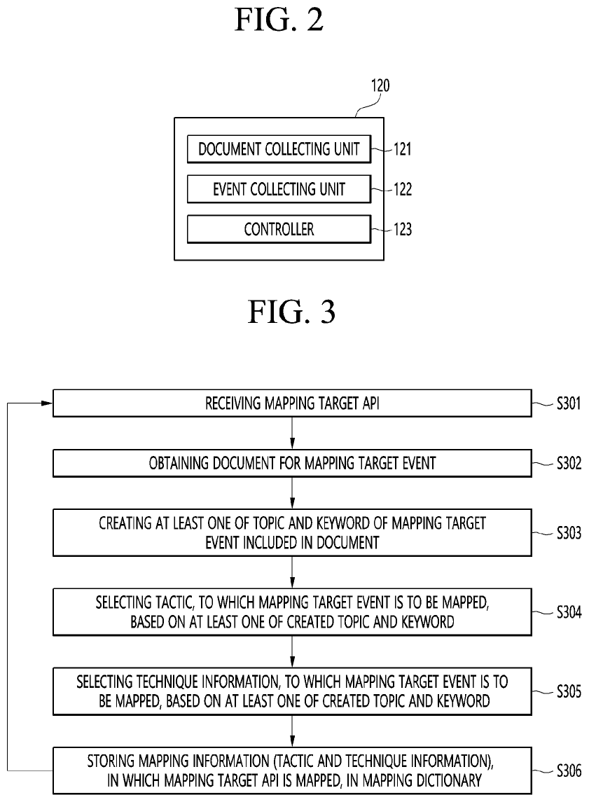

FIG. 2 is a block diagram of a processor of a mapping server according to an embodiment of the present disclosure. Referring to FIG. 2, the processor 120 may include a document collecting unit 121, an event collecting unit 122, and a controller 123.

The document collecting unit 121 may collect documents for a mapping target event from the document server 20. The event collecting unit 122 may access the event recorder, in which event information on results of API execution by the API server 10 is stored in the form of a database, to collect event information corresponding to an executed API at a predetermined period, at a predetermined time interval, or in real time.

Here, collecting event information may be determined by considering a query request speed of the event recorder of the server in order to prevent a traffic or data deadlock. In addition, inquiry request speed information may also be received from a cloud trail. For example, when the event recorder is a cloud trail of AWS, it may be limited to 2 times per second or less for each region or for each account, and it may take up to 15 minutes for a result to be provided through the cloud trail. Accordingly, a time interval for collecting APIs from a cloud trail may be determined within a range that satisfies the aforementioned limitations.

The controller 123 may generate mapping information for a mapping target event in association with the document collecting unit 121, the event collecting unit 122, and the action database 140. Of course, the controller 123 may map risk information for a tactic of the mapping information, together with the mapping information. The risk information may include default risk information of the corresponding mapping target event itself, and risk relevance information in which a first event occurring in sequence with the mapping target event is taken into consideration.

FIG. 3 is an overall flowchart of a method for generating mapping information for an API according to an embodiment of the present disclosure. Referring to FIG. 3, in operation S301, the processor 120 receives one mapping target event occurring in a first account from the API server 10. Then, in operation S302, the processor 120 obtains a document for the received mapping target event from the document server 20.

In operation S303, the processor 120 generates at least one of a topic and a keyword of the mapping target event, by using a name of an API included in the document for the mapping target event, a definition of the API, a function of the API, and a request syntax format of the API, and a description of a parameter generated or provided upon execution of an API. For example, if the mapping target event is an event for account update, the processor 120 may generate a topic of “account update” or keywords of “account” and “update”.

In operation S304, the processor 120 selects one tactic from among a plurality of tactics stored in the action database 140 based on the topic or keyword generated in operation S303. Then, in operation S305, the processor 120 selects at least one technique corresponding to the topic or keyword generated in operation S303 from among a plurality of techniques included in the selected tactic.

After performing operations S304 and S305, the processor 120, in operation S306, sets the tactic selected in operation S303 and the technique selected in operation S304 as mapping information for the mapping target event, and stores the mapping target event and the mapping information for the mapping target event in the mapping dictionary by matching the mapping information to the mapping target event.

Thus, when operations S301 to S306 are performed on a plurality of mapping target events, mapping information for the plurality of events among all events may be recorded in the mapping dictionary, and unless there is no more events, the mapping dictionary may become to contain mapping information for all the events over time.

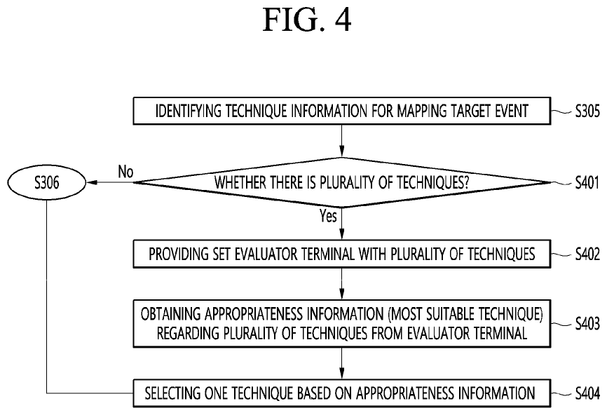

FIG. 4 is a flowchart illustrating a process when a mapping target event corresponds to a plurality of techniques according to an embodiment of the present disclosure. Referring to FIG. 4, in operation S305 described above, the processor 120 selects (identifies) a technique corresponding to a topic or keyword of one mapping target event from among a plurality of techniques included in the selected tactic.

In operation S401, the processor 120 determines whether there are two or more techniques identified in operation S305. In addition, when one technique is identified according to a result of the determination, the processor 120 performs operation S306. However, when two or more techniques are identified, the processor 120 performs operation S402 to provide a plurality of evaluator terminal 40 with the plurality of techniques identified in operation S305, as well as the topic or keyword of the mapping target event.

As such, when the topic or keyword and the plurality of techniques are provided to each evaluator terminal 40, each evaluator identifies the topic or keyword and then selects one of the plurality of techniques most suitable for the topic or keyword to mark or tag the selected one with “appropriate” or marks each of the plurality of techniques with a degree of matching with the topic or keyword, that is, a score or level of appropriateness. Here, a degree of appropriateness may be information of “appropriate”, a score of appropriateness, or a level of appropriateness.

Subsequently, the processor 120 obtains (receives) appropriateness information for the plurality of techniques from the plurality of evaluator terminals 40 in operation S403. Then, in operation S404, the processor 120 selects one technique with a largest number of “adequate” marks or tags. Alternatively, the processor 120 averages the scores or levels assigned to each technique and selects one technique with a highest average value.

Then, the processor 120 stores the technique selected in operation S404 and one tactic selected in operation S304 as mapping information for the mapping target event in the mapping dictionary as in operation S306.

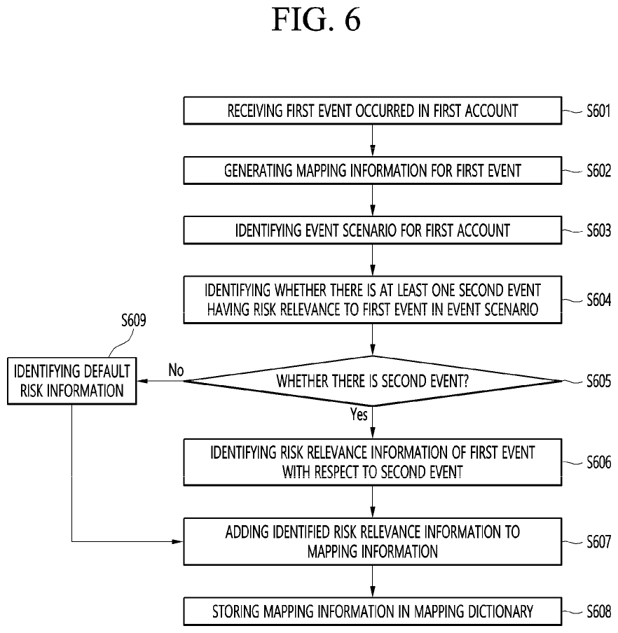

FIG. 6 is a flowchart illustrating a process of generating risk information according to an embodiment of the present disclosure. Referring to FIG. 6, in operation S601, the processor 120 receives a first event (including a first API) occurring in a first account. Then, in operation S602, the processor 120 generates mapping information by selecting one tactic for the first event and one technique among a plurality of techniques included in the tactic, as described above.

In operation S603, the processor 120 identifies an event scenario regarding the first account. The event scenario is a sequence of events in time series. For example, suppose that the first event occurred in the first account on Jul. 1, 2022, the second event occurred in the first account on Jul. 2, 2022, the third event occurred in the first account on Aug. 31, 2022, and a fourth event has occurred as of today (Sep. 15, 2022). In this case, the first event, the second event, the third event, and the fourth event are listed in the event scenario in chronological order. Based on the chronological order of the events included in the event scenario, a tactic or technique associated with the corresponding event may be identified.

In operation S604, the processor 120 identifies whether there is at least one second event (or a tactic or technique thereof) having a risk relevance to the first event or a tactic or technique thereof in the identified event scenario. Identifying the second event is performed using a pre-stored risk table. In the risk table, a type and risk information (default risk information or risk relevance information) of each event in risk relevance to a risk event are recorded. The risk information may be recorded as a risk level or risk score.

In operation 605, the processor 120 determines whether there is a second event. When there is a second event, the processor 120 determines risk relevance information of the first event with respect to the second event in operation S606.

The processor 120 adds the risk relevance information determined in operation S605 to mapping information in operation S606, and stores the mapping information in a mapping dictionary in operation S607.

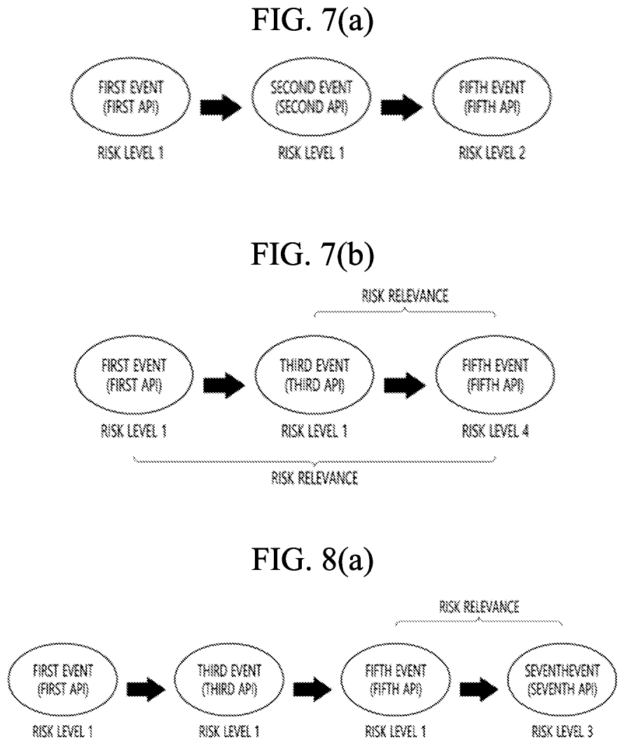

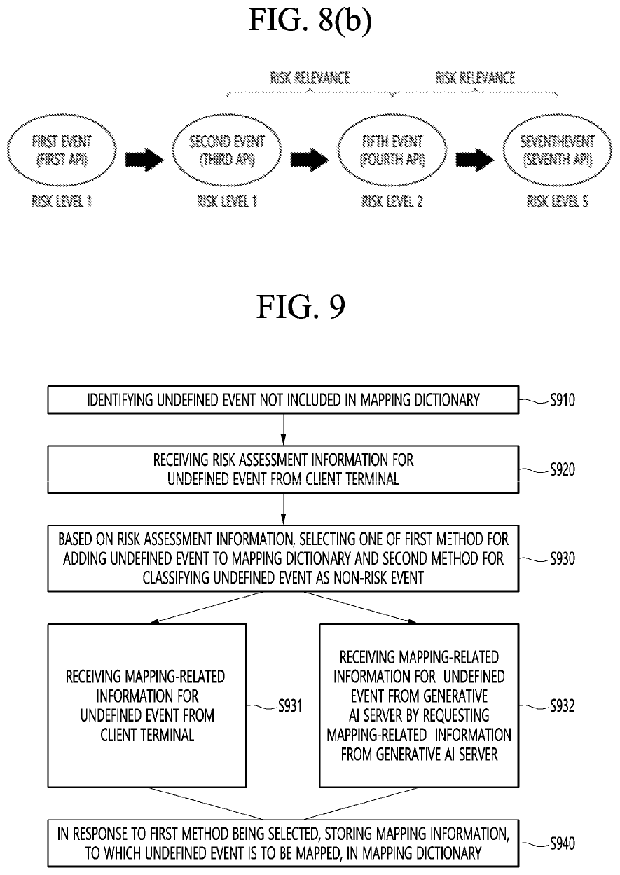

Hereinafter, identifying risk information will be described in detail with reference to FIGS. 7(a), 7(b), 8(a) and 8(b).

FIGS. 7(a) and 7(b) are diagrams illustrating an operation of determining a risk level based on a risk relevance in an action scenario according to a first embodiment of the present disclosure.

Referring to FIG. 7(a), it is assumed that there is a first event scenario having a sequence of a first event (including a first API), a second event (including a second API), and a fifth event (a fifth API). If an event (or tactic or technique) of the first event scenario has no risk relevance, the processor 120 assigns default risk information to the event. For example, risk level 1, which is the lowest risk level, is assigned to the first event and the second event, and risk level 2, which is the default risk information based on a tactic to which the fifth API is mapped, is assigned to the fifth event.

However, as shown in FIG. 7(b), in the case of a second event scenario having a sequence of a first event (including a first API), a third event (including a third API), and a fifth event (a fifth API), if the first event has a risk relevance to the fifth event or the third event has a risk relevance to the fifth event, the processor 120 assigns risk level 4 to the fifth event and determines that the fifth event of the second scenario has a higher risk than the fifth event of the first event scenario.

Therefore, although the fifth event are the same in FIGS. 7(a) and 7(b), the fifth event of the first scenario and the fifth event of the second scenario may be given different risk levels or risk scores depending on whether the fifth event has a risk relevance to the type of an event (type of tactic or type of technique) that occurred right before the fifth event.

FIGS. 8(a) and 8(b) are diagrams illustrating an operation of determining a risk level based on a risk relevance in an action scenario according to a second embodiment of the present disclosure. Referring to FIGS. 8(a) and 8(b), if an event frequently has a risk relevance in an event scenario, the event may be given a higher risk level.

Referring to FIG. 8(a), in the case of a third event scenario having a sequence of a first event (including a first API), a third event (including a third API), a fifth event (including a fifth API), and a seventh event (including a seventh API), the seventh event has a risk relevance to the fifth event and thus is given risk level 3 while the first, third, and fifth events are given the default risk information.

On the other hand, referring to FIG. 8(b), in a third event scenario having a sequence of a first event (including a first API), a second event (including a second API), a fifth event (including a fifth API), and a seventh event (including a seventh API), the fifth event has a risk relevance to the second event and thus is given risk level 2 which is the risk relevance information, and the seventh event is given risk level 5 higher than that of the seventh event in FIG. 8(a) since the fifth event has a risk level higher than that of the fifth event in FIG. 8(a).

Accordingly, if a specific event has a risk relevance to a larger number of other events in an event scenario, the event may be given a higher risk level, compared to a different scenario in which the same event has a risk relevance to a smaller number of other events.

FIG. 9 is an overall flowchart of a method for mapping an undefined event according to an embodiment of the present disclosure.

In operation S910, the processor 120 identifies an undefined event not included in a mapping dictionary.

Here, the undefined event refers to a code or software that does not generate a separate execution flow or event. Specifically, the undefined event may be a software component that does not generate its own execution flow or event, but is operated upon a request from another application or activated by another code. For example, the undefined event may be libraries, middleware, lambda layers, etc.

In operation 920, the processor 120 receives risk assessment information on the undefined event from a client terminal 30.

Here, the risk assessment information may include information on what kind of risk the undefined event could pose to the system. For example, the risk assessment information may be information on a type of the undefined event, an extent of possible impact, and the existence and severity of vulnerability. Alternatively, the risk assessment information may be information indicating that a client's classification of the undefined event as either a risk event or a non-risk event.

In operation S930, the processor 120 selects one of a first method for adding the undefined event to the mapping dictionary and a second method for classifying the undefined event as a non-risk event based on the risk assessment information.

Here, the first method is a method for analyzing the undefined event, selecting an associated tactic and technique, and adding the associated tactic and technique to the mapping dictionary when the undefined event is determined to pose a risk to the system based on the risk assessment information.

Here, the second method is a method for classifying the undefined event without additional process or analysis when the undefined event is not determined to pose a risk to the system based on the risk assessment information, so that the undefined event is not mapped to a mapping tactic and technique. For example, when risk assessment information “This data is related to the normal operation of the system, so there is no need to consider it as a threat” regarding a specific undefined event is received from the client terminal 30, the undefined event may not be added to the mapping dictionary and excluded from security analysis or monitoring.

Operations S931 and S932 may be included between operations S930 and S940. Operations S931 and S932 may be incorporated.

In operation S931, the processor 120 receives mapping-related information for the undefined event from the client terminal 30.

Here, the mapping-related information is information necessary for mapping the undefined event to a specific tactic or technique, and may be based on at least one of topic and keyword information of the undefined event. The processor 120 may generate mapping information based on the mapping-related information received from the client terminal 30.

In operation S932, the processor 120 receives the mapping-related information from a generative AI server by requesting the mapping-related information for the undefined event from the generative AI server.

The generative AI may generate the mapping-related information for the undefined event based on learning data and algorithm stored therein. Also, the generative AI may generate mapping information based on the generated mapping-related information.

In operation S940, if the first method is selected, the processor 120 stores mapping information, to which the undefined event is to be mapped, in the mapping dictionary. The processor 120 generates the mapping information based on the mapping-related information received in operations S931 and S932, and stores the generated mapping information in the mapping dictionary.

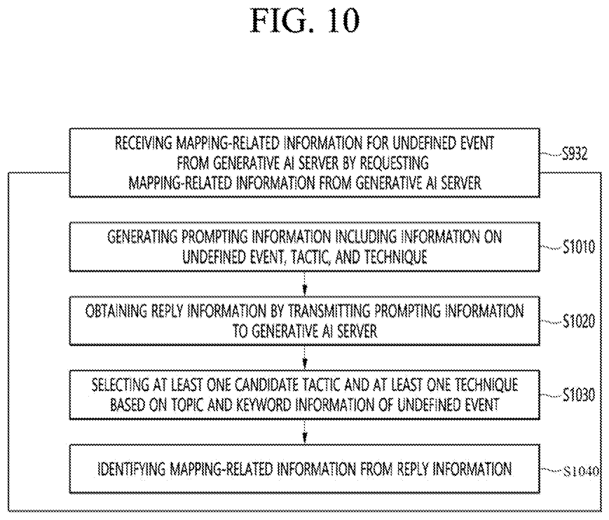

FIG. 10 is an overall flowchart of a method for receiving mapping-related information from a generative AI server according to an embodiment of the present disclosure.

In operation S1010, the processor 120 selects at least one candidate tactic and at least one candidate technique based on the topic and keyword information of the undefined event. For example, if the topic and keyword information of the undefined event is “non-allowed file upload”, “user”, “file upload”, and “non-allowed file”, “Impact” may be selected as a candidate tactic based on the MITER ATT&CK framework and “Data Destruction” or “Denial of Service” may be selected as a candidate technique.

In operation S1020, the processor 120 generates prompting information including information on the undefined event, tactics, and techniques.

Here, the prompting information is information necessary to send a request to the generative AI server. Also, the information on tactics and techniques may be information on the candidate tactic and technique selected in operation S1010. For example, the processor 120 may analyze the undefined event, extract information on potentially related tactics and techniques, and include the extracted information in the prompting information.

In operation S1030, the processor 120 obtains reply information by transmitting the prompting information to the AI server.

Based on the prompting information, the generative AI server returns the reply information as a tactic and a technique suitable for the undefined event. Here, the reply information may include mapping information for the undefined event.

In operation S1040, the processor 120 identifies mapping-related information from the reply information.

According to an embodiment of the present disclosure, it is possible to immediately identify an action and a risk thereof based on tactics and techniques that are mapping information for cloud events occurring in an account.

The technical features disclosed in each embodiment of the present disclosure are not limited only to a corresponding embodiment, but the technical features in the respective embodiments may be combined and applied to different embodiments unless they are mutually incompatible.

Therefore, although each embodiment has been described mainly about a technical feature thereof, the technical features may be combined unless they are mutually incompatible.

The present disclosure is not limited to the above-described embodiment and the accompanying drawings, and various modifications and changes may be made in view of the person skilled in the art to which the present disclosure pertains. The scope of the invention should, therefore, be determined by equivalents to the claims, as well as by the claims of the present disclosure.

What is claimed is:

1. A method for generating mapping information for a plurality of events provided by a cloud service by a mapping server, wherein the mapping server is capable of using an action database comprising a plurality of techniques included in any one of a plurality of tactics, and wherein the method comprises:
(a) obtaining a document for any one mapping target event, wherein the mapping target event is any one of the plurality of events;
(b) generating at least one of a topic and a keyword for the mapping target event based on the document;
(c) selecting one tactic to which the mapping target event is mapped, based on at least one of the topic and the keyword;
(d) selecting a technique to which the mapping target event is mapped, based on at least one of the topic and the keyword, wherein the selected technique is included in the selected tactic;
(e) storing mapping information for the mapping target event according to (c) and (d) in a mapping dictionary; and
(f) generating a mapping dictionary for at least some of the plurality of events by repeating (a) to (d).

2. The method of claim 1, further comprising:
(g) obtaining information on an inquiry event from a client;
(h) searching for a tactic corresponding to the inquiry event based on the mapping dictionary;
(i) searching for one of a plurality of techniques included in the searched tactic; and
(j) providing the client with the technique and tactic searched for with respect to the inquiry event as mapping information.

3. The method of claim 1, wherein (d) comprises:
selecting a plurality of techniques possibly mapped to the mapping target event;
providing the plurality of techniques to at least one evaluator terminal;
obtaining appropriateness information for the plurality of techniques from the at least one evaluator terminal;
selecting one technique from among the plurality of techniques by collecting the appropriateness information; and
storing mapping information for the mapping target event in the mapping dictionary.

4. The method of claim 1, wherein the mapping information comprises risk information for the mapping target event.

5. The method of claim 4, wherein the risk information comprises default risk information for the mapping target event, and risk relevance information in which a first event occurring in sequence with the mapping target event is taken into consideration.

6. The method of claim 5, wherein when the first event is plural, the risk relevance information is matched with each first event.

7. The method of claim 5, wherein when an inquiry event scenario having a plurality of inquiry events is received from a client, different risk information is selected for each of the plurality of inquiry events in consideration of a technique or tactics of any other inquiry event occurring earlier in the inquiry event scenario.

8. The method of claim 1, wherein the processor is further configured to perform the following:
(k) identifying an undefined event not included in the mapping dictionary;
(l) receiving risk assessment information on the undefined event from a client terminal;
(m) based on the risk assessment information, selecting one of a first method for adding the undefined event to the mapping dictionary and a second method for classifying the undefined event as a non-risk event; and
(n) in response to the first method being selected, storing mapping information, to which the undefined event is to be mapped, in a mapping dictionary.

9. The method of claim 8, wherein:
the processor is further configured to perform, after (m) and prior to (n), receiving mapping-related information for the undefined event from the client terminal, and in (n), the mapping information is generated based on the mapping-related information.

10. The method of claim 9, wherein the mapping-related information is based on at least one of topic and keyword information of the undefined event.

11. The method of claim 8, wherein:
the processor is further configured to perform, after (m) and prior to (n), receiving mapping-related information for the undefined event from a generative AI server by requesting the mapping-related information from the generative AI server, and in (n), the mapping information is generated based on the mapping-related information.

12. The method of claim 11, wherein the receiving of the mapping-related information comprises:
generating prompting information comprising information on the undefined event, the tactic, and the technique;
obtaining reply information by transmitting the prompting information to the generative AI server; and
identifying the mapping-related information from the reply information.

13. The method of claim 12, wherein:
the receiving of the mapping-related information comprises, prior to the generating of the prompting information, selecting at least one candidate tactic and at least one candidate technique based on topic and keyword information of the undefined event; and
in the generating of the prompting information, the information on the tactic and the technique included in the prompting information is information on the at least one candidate tactic and at least one candidate technique.

14. A mapping server for generating mapping information for a plurality of events provided by a cloud service, the server comprising:
a memory;
an action database comprising a mapping dictionary, a plurality of tactics, and a plurality of techniques included in each of the plurality of tactics; and
a processor connected to the memory and the action database and executing instructions stored in the memory,
wherein the processor is configured to perform the following:
(a) obtaining a document for any one mapping target event, wherein the mapping target event is any one of the plurality of events;
(b) generating at least one of a topic and a keyword for the mapping target event based on the document;
(c) selecting one tactic to which the mapping target event is mapped, based on at least one of the topic and the keyword;
(d) selecting a technique to which the mapping target event is mapped, based on at least one of the topic and the keyword, wherein the selected technique is included in the selected tactic;
(e) storing mapping information for the mapping target event according to (c) and (d) in a mapping dictionary; and
(f) generating a mapping dictionary for at least some of the plurality of events by repeating (a) to (d).

15. The mapping server of claim 14, wherein the processor is further configured to perform the following:
(g) obtaining information on an inquiry event from a client;
(h) searching for a tactic corresponding to the inquiry event based on the mapping dictionary;
(i) searching for one of a plurality of techniques included in the searched tactic; and
(j) providing the client with the technique and tactic searched for with respect to the inquiry event as mapping information.

16. The mapping server of claim 14, wherein the processor is further configured to perform the following in (d):
selecting a plurality of technique information possibly mapped to the mapping target event;
providing the plurality of techniques to at least one evaluator terminal;
obtaining appropriateness information for the plurality of techniques from the at least one evaluator terminal;
selecting one technique from among the plurality of techniques by collecting the appropriateness information; and
storing mapping information for the mapping target event in a mapping dictionary.

17. The mapping server of claim 14, wherein the mapping information comprises risk information for the mapping target event.

18. The mapping server of claim 17, wherein the risk information comprises default risk information for the mapping target event and risk relevance information in which a first event occurring in sequence with the mapping target event is taken into consideration.
